(19) United States
(12) Patent Application Publication
(10) Pub. No.: US 2009/0104427 A1
(43) Pub. Date: Apr. 23, 2009

(54) Multi-Properties Composite, Polytetrafluoroethylene Membrane and Preparation Thereof

(75) Inventors: Lai-Hung Wan, Taipei Hsien (TW); Shuo-Ting Hung, Taipei Hsien (TW); Kuo-Chin Chen, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: MAGICTEX APPAREL CORPORATION, Taipei Hsien (TW)

(21) Appl. No.: 11/946,732

(22) Filed: Nov. 28, 2007

(30) Foreign Application Priority Data
Oct. 22, 2007 (CN) 200710181776.8

(51) Int. Cl. B32B 5/18; B32B 3/00

(52) U.S. Cl. 428/315.7; 428/316.6; 521/99; 427/385.5

(57) ABSTRACT

The present invention relates to a kind of composite of porous resin and porous carbon particles, which has excellent adsorption, odor resistance, moisture-management, air permeability, water vapor permeability, water resistance and anti-peeling properties. Moreover, a kind of adsorbent, odor resistant, moisture-managing, air permeable, water vapor permeable, water resistant and anti-peeling polytetrafluoroethylene and its processing method are also disclosed.

### FIELD OF THE INVENTION

The present invention relates to a composite with adsorbent, odor resistant, moisture-managing, air permeable, water vapor permeable, water resistant and anti-peeling composite. The composite can attach to porous polytetrafluoroethylene by coating or dipping, and can enable polytetrafluoroethylene to have adsorption, odor resistance, moisture-management, air permeability, water vapor permeability, water resistance and anti-peeling properties.

### BACKGROUND OF THE INVENTION

Polytetrafluoroethylene (C₂F2, PTFE), like TEFLON, is conventionally prepared by polymerizing tetrafluoroethylene monomers in a chain reaction and is thus simply composed of carbon particles and fluorine atoms without hydrogen atoms so that polytetrafluoroethylene does not react with oxygen and has characteristics such as thermal resistance, cold resistance, erosion resistance and a non-stickiness property, low friction coefficient and self-lubrication property etc. Moreover, polytetrafluoroethylene does not easily fuse and attach with other materials so that it is widely applied in plastic manufacturing field.

Because polytetrafluoroethylene has above advantages, manufacturers process polytetrafluoroethylene to make polytetrafluoroethylene sheets or membranes that are porous and suitable to laminate on textile or non-textile to serve as a filter as described in U.S. Pat. Nos. 5,234,739, 6,080,472 and 5,750,242, R.O.C. patent Nos. 538164, 592783 and publication No. 200621496.

The application which combines porous carbon particles and polytetrafluoroethylene was used in composite materials, electronic materials (electrodes), low dielectric materials and fireproof textiles, and was described in Japan patent Nos. 6316784, 61049377 and 55023039, U.S. Pat. No. 4,436,169, Swiss patent No. 671707 and Germany patent No. 4137627.

The manufactured products, composite materials of polytetrafluoroethylene and porous carbon particles, made by the processes in the mentioned patents mostly are applied to cloth manufacturing, composite materials and electronic devices utilizing their characteristics of thermal resistance, insulation and erosion resistance. The applications of the combination of porous polytetrafluoroethylene and porous carbon particles still has not been disclosed.

Furthermore, polytetrafluoroethylene membrane is conventionally applied to cloth manufacturing because of its porous structure and characteristics of air permeability, water vapor permeability and water pressure-resistance. However, continuous washing and scrubbing would destroy the structure of the membrane and peel the surface, as well as, decreasing the water pressure-resisting property. Moreover, porous carbon particles have porous and high specific surface area, which can absorb toxic gas or volatilizable organic solvent in air that may threaten human health, in addition to it their moisture-management properties. It is an innovative integrated application that combines the two foregoing materials and advantages thereof to produce an adsorption, odor resistance, moisture-management, air permeability, water vapor permeability, water resistance and anti-peeling polytetrafluoroethylene membrane, which can maintain the original characteristics of the membrane, such as air permeability, water vapor permeability, high water pressure-resistance.

According to the prior art, the composite material combining porous polytetrafluoroethylene membrane with porous carbon particles have not been applied to cloth manufacturing and is necessary to the market.

### SUMMARY OF THE INVENTION

The present invention provides a composite comprising:
(1) a porous carbon particle; and
(2) a porous resin,
wherein the porous carbon particle is uniformly distributed and exposed outside on the surface of the porous resin.

The present invention further provides a method of preparing a composite with adsorption, odor resistance, moisture-management, air permeability, water vapor permeability, water resistance and anti-peeling property comprising steps of:
(1) mixing a porous resin with a solvent which entirely or partially dissolves in water;
(2) mixing the porous carbon particles with a solvent which entirely or partially dissolve in water; and
(3) adding the mixture of Step (2) to the mixture of Step (1) slowly to distribute the porous carbon particles uniformly in the porous resin, and then fixing the mixture by curing from low temperature to high temperature.

The present invention further provides a method of preparing a porous polytetrafluoroethylene membrane with adsorption, odor resistance, moisture-management, air permeability, water vapor permeability, water resistance and anti-peeling property comprising steps of:
(1) mixing a porous carbon particle with porous resin and a solvent which entirely or partially dissolves in water to obtain a composite.
(2) distributing the composite uniformly to the surface of a polytetrafluoroethylene membrane or within it by coating or dipping; and
(3) drying out the membrane to remove the solvent and then attaching the composite to the surface of a polytetrafluoroethylene membrane or within it.

### DETAILED DESCRIPTION OF THE INVENTION

The term “anti-peeling property of composite” used herein relates to enable an easily-peeling cloth or membrane to have anti-peeling property.

The term “air permeability property of composite” used herein means the composite without affecting the original air permeability of cloth or membrane.

The other terms all have the same meanings as the interpretation of persons skilled in this art.

The present invention provides a kind of composite, which comprises porous carbon particles and porous resin, the porous carbon particles are distributed and exposed outside uniformly on the surface of the porous resin to contact easily with toxic gas particles or odd gas particles; the present invention further contains a solvent, the solvent can be isopropanol, methyl ethyl ketone, ketone, water, toluene, N-dimethylformamide or mixture thereof. The porous carbon particles are selected from the group consisting of free activated charcoal, carbon black, and graphite whose diameter is between 0.1-1 micrometers; the porous resin is consisted of polyurethane, phthalate, or derivatives thereof.

In the composite of the present invention, the percentage of the porous carbon particles is 1-30(w/w %); preferred percentage of the porous carbon particles is 2-25(w/w %); the most preferred percentage of the porous carbon particles is 3-10(w/w %); wherein the percentage of the porous resin is 10-70(w/w %); preferred percentage of the porous resin is 20-55(w/w %); the most preferred percentage of the porous resin is 30-50(w/w %); wherein the percentage of the solvent is 30-80(w/w %); preferred percentage of the solvent is 40-70(w/w %); the most preferred percentage of the solvent is 50-65(w/w %).

The porous carbon particles is a porous and high specific-surface-area material, which can which can absorb toxic gas or volatilizable organic solvent in air that threaten human health; it also has moisture-management properties. In the composite of the present invention, wherein the porous carbon particles were distribute and exposed outside uniformly on the surface of the porous resin to contact with the air easily, giving characteristics of adsorption, odor resistance, and moisture-management properties. Furthermore, the porous composite of the present invention also includes the characteristics of air permeability, water vapor permeability, water resistance and anti-peeling properties to protect polytetrafluoroethylene membrane.

The present invention further provides a porous polytetrafluoroethylene membrane which has the characteristics of adsorption, odor resistance, moisture-management, air permeability, water vapor permeability, water resistance and anti-peeling properties, which including a kind of composite with the characteristics of adsorption, odor resistance, moisture-management, air permeability, water vapor permeability, water resistance and anti-peeling properties and a porous polytetrafluoroethylene membrane, wherein the composite is attached to the surface of the polytetrafluoroethylene membrane or within it.

Moreover, the present invention further provides a process to prepare a porous polytetrafluoroethylene membrane which has the characteristics of adsorption, odor resistance, moisture-management, air permeability, water vapor permeability, water resistance and anti-peeling properties: First, mix the porous carbon particles with the porous resin and solvent to obtain a composite which has the characteristics of adsorption, odor resistance, moisture-management, air permeability, water vapor permeability, water resistance and anti-peeling property; Second, distribute the composite uniformly on the surface of the porous polytetrafluoroethylene membrane or within it by coating or dipping; Finally, fix the membrane by curing and remove the solvent to attach the composite to the surface of the polytetrafluoroethylene membrane or within it.

### BRIEF DESCRIPTION OF THE DRAWINGS

FIGS. 1 (a) and (b) are the composite of the present invention, which consists of porous carbon particles 10 and porous resin 20. The composite is attached to an expanded polytetrafluoroethylene (ePTFE) membrane 30 in FIG. 1 (the attachment can be done through coating or dipping).

FIG. 2 (a) (2,500×) and (b) (10,000×) are the pictures of the composite of the present invention under a scanning electron microscope (SEM).

FIG. 3 shows the use of the composite of the present invention in the manufacture process of porous polytetrafluoroethylene membranes.

FIG. 4 shows the contrast of the water-pressure resistance. Treating with the composite could increase the water-pressure resistance of a porous polytetrafluoroethylene membrane and the durability thereof.

The invention is illustrated by the following non-limiting examples.

### EXAMPLES

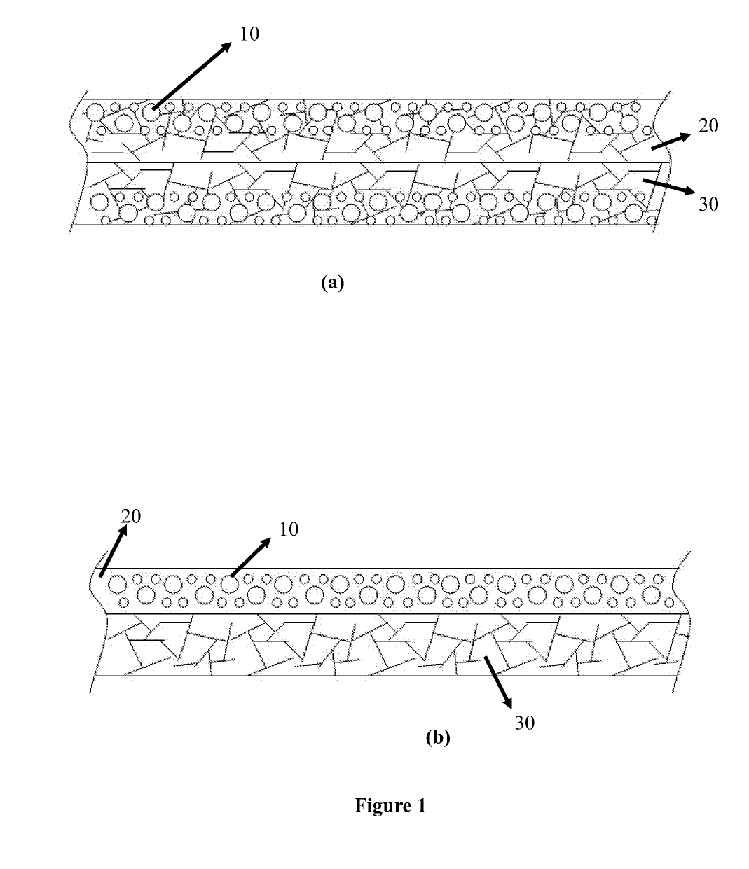

As shown in FIG. 1, the composite of the present invention consisting of porous carbon particles and porous resin could attach to the polytetrafluoroethylene membrane and enable it have the characteristics of adsorption, odor resistance, moisture-management, air permeability, water vapor permeability, water resistance and anti-peeling properties. In addition, the polytetrafluoroethylene membrane did not lose its original air permeability, water vapor permeability and water pressure-resisting properties.

The manufacture process of the membrane of the present invention would be specified in the following examples and figures.

### Example 1

### Manufacture Process of the Composite

The composite of the present invention was a kind of porous material consisting of 6% porous carbon particles, 50% porous resin and 44% solvent mixed by stirring for 2 to 30 min. The solvent could be ketone, water, toluene, N-dimethylformamide or mixtures thereof. The porous carbon particles were selected from the group consisting of carbon black, free activated charcoal, carbon black, and graphite. There were three steps in the manufacture process:

Step 1: Mixing the porous resin with toluene or N-dimethylformamide by stirring (named mixed resin).

Step 2: Mixing the porous carbon particles with ketone or water by stirring (named mixed solution).

Step 3: Adding the mixed solution to the mixed resin slowly to distribute the porous carbon particles uniformly in the porous resin, and then fixing the mixture by curing at 70˜180° C. from low temperature to high temperature.

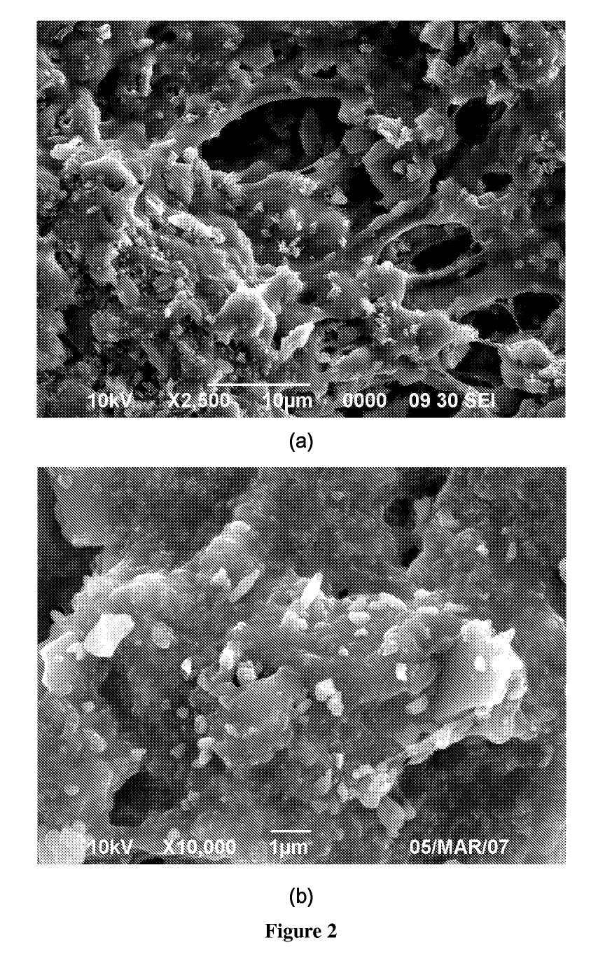

As shown in FIG. 2, the porous carbon particles would be exposed outside on the surface of the porous resin when the solvent evaporated, and the resin would retain the original characteristics of adsorption, odor resistance, and moisture-management properties. Moreover, the percentage of the porous resin in Step 1 was 30-50%; the percentage of the toluene or N-dimethylformamide in Step 1 was 50-70%; the percentage of the porous carbon particles in Step 2 was 3-10%; the percentage of ketone and water in Step 2 was 90-97%; the ratio of the mixed solution and mixed resin in Step 3 was 3:7. The porous composite of the present invention obtained the characteristics of adsorption, odor resistance, moisture-management air permeability, water vapor permeability, water resistance and anti-peeling properties due to the porous carbon particles which has the adsorption, odor resistance, moisture-management properties.

### Example 2

### Preparation of a Porous Polytetrafluoroethylene Membrane with Adsorption, Odor Resistance, Moisture-Management Air Permeability, Water Vapor Permeability, Water Resistance and Anti-Peeling Properties

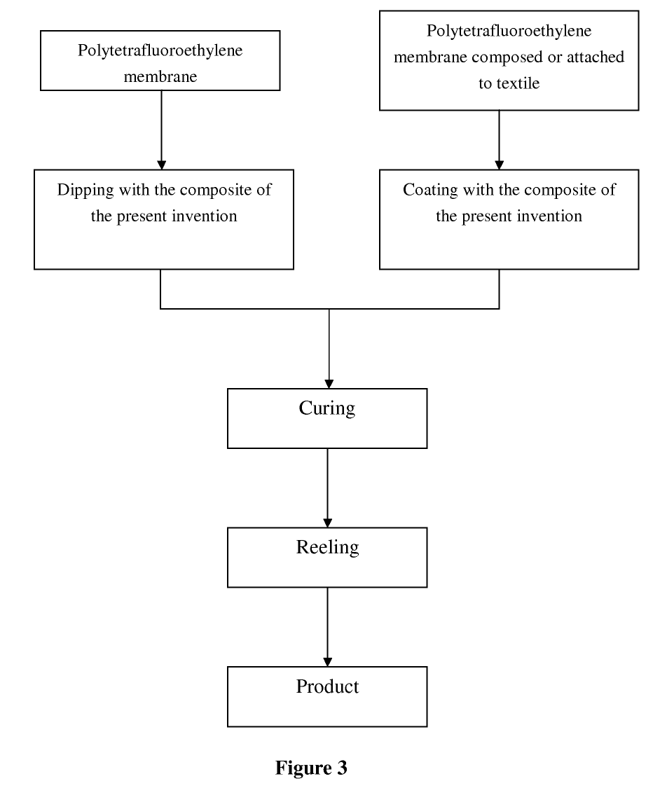

FIG. 3 showed the application of the “composite of porous resin and porous carbon particles, which has adsorption, odor resistance, moisture-management, air permeability, water vapor permeability, water resistance and anti-peeling properties” of the present invention in manufacture process of porous polytetrafluoroethylene membranes. The present invention provided two methods, dipping and coating, to prepare a kind of porous polytetrafluoroethylene membrane which has the characteristics of adsorption, odor resistance, moisture-management, air permeability, water vapor permeability, water resistance and anti-peeling properties. The two methods were specified as following.
(1) Preparation of a kind of porous polytetrafluoroethylene membrane and textile thereof which has the characteristics of adsorption, odor resistance, moisture-management, air permeability, water vapor permeability, water resistance and anti-peeling properties by dipping. The preparation process by dipping included 4 steps, feeding, dipping, curing, and reeling. First, the porous polytetrafluoroethylene was shaped into a roll in feeding device. Second, the porous polytetrafluoroethylene entered into a dipping device, which contained a roller, a pressing roller, a dipping tank and a scraping roller. The porous polytetrafluoroethylene was expanded in the roller, and then entered the dipping tank filled with the composite of Example 1 through the pressing device, and then passed into the scraping device to finish dipping. Third, the porous polytetrafluoroethylene with the composite of the present invention entered a curing device and was dried out at 70˜180° C. for 30˜180 seconds. Finally, the treated porous polytetrafluoroethylene was shaped into a roll with a desired size to serve as a final product. The foregoing process was a continuous process.
(2) Preparation of a kind of porous polytetrafluoroethylene membrane and textile with adsorption, odor resistance, moisture-management, air permeability, water vapor permeability, water resistance and anti-peeling property by coating. The preparation process by coating included 4 steps, feeding, coating, curing, and reeling. First, the porous polytetrafluoroethylene was shaped into a roll in feeding device. Second, the porous polytetrafluoroethylene entered into a coating device, which contained a roller and a coating apparatus. The porous polytetrafluoroethylene was expanded in the roller, and the coating apparatus could coat the composite of Example 1 directly to the porous polytetrafluoroethylene. Third, the porous polytetrafluoroethylene with the composite of the present invention entered a curing device and was dried out at 70˜180° C. for 30˜180 seconds. Finally, the treated porous polytetrafluoroethylene membrane was shaped into a roll with a desired size to serve as a final product. The foregoing process was a continuous process.

### Example 3

### Test of Air Permeability, Water Vapor Permeability, Water Resistance and Anti-Peeling Property

As shown in Table 1, the porous polytetrafluoroethylene membrane treated with the composite of the present invention was tested for its air permeability, water vapor permeability and water-pressure resisting property, and an untreated one was used as a control.

TABLE 1

| | | | | treaded with 6% |
|---|---|---|---|---|
| | | | | composite |
| | | | | of the present |
| sample | | | untreated | invention |
| Water-resistance | JIS-L1092: | 25X | 1350 | 6633 |
| (mmH2O) | 1998-6.1 | 15X | 1550 | 8783 |
| | | 5X | 5216 | 12716 |
| | | 0X | 15000 | 14333 |

| | | | |
|---|---|---|---|
| Water vapor | JIS-L1099-1993-A1 | 6909 | 8335 |
| transmission | | | |
| (g/m²/24 hr) | | | |
| Wind-proof(cfm) | ASTM-D737 1996 | 0.02~0.1 | 0.02~0.1 |

### (1) Comparison of Air Permeability Property

Through the test of ASTM (American Society for Testing and Materials Standards)-D727 1996, the untreated porous polytetrafluoroethylene membrane could exhaust air 0.02˜0.1 cubic feet, so the air permeability was 0.02˜0.1 cfm (cubic feet per minute). The treated one had the same testing data with the untreated one, so the porous polytetrafluoroethylene membrane could remain its air permeability after being treated with the composite of the present invention.

### (2) Comparison of Water Vapor Permeability Property

Through the test of JIS (Japan Industrial Standards)-L1099-1993-A1, 6,909 grams of gas could pass through the untreated porous polytetrafluoroethylene membrane per square meter in 24 hours, so the water vapor permeability property was 6,909 g/M²/24 hr. 8,335 grams of gas could pass through the treated one per square meter in 24 hours, so the water vapor permeability property was 8,335 g/M²/24 hr. Therefore, the porous polytetrafluoroethylene membrane could increase its water vapor permeability property by treating with the composite of the present invention.

### (3) Comparison of Water-Pressure Resisting Property

Through the test of JIS-L1092-1998-6.1, the original water-pressure resistance of the untreated porous polytetrafluoroethylene membrane was 15,000 mmH₂O, and then decreased to 5,216 mmH₂O after 5 times of laundry, 1,550 mmH₂O after 15 times of laundry, and 1,350 mmH₂O after 25 times of laundry. The original water-pressure resistance of the treated one was 14,333 mmH₂O, and then decreased to 12,716 mmH₂O after 5 times of laundry, 8,783 mmH₂O after 15 times of laundry, and 6,633 mmH₂O after 25 times of laundry.

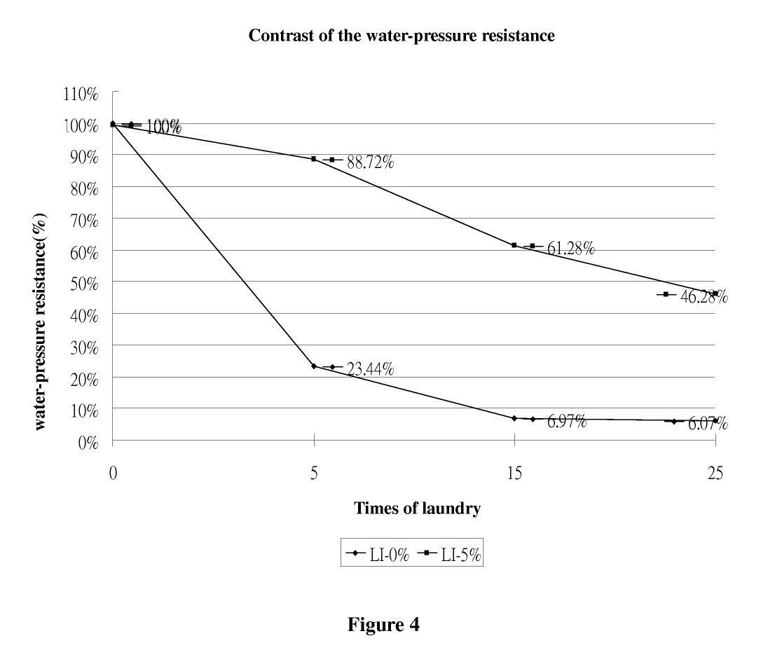

With regard to the test, the water-pressure resistance of an untreated porous polytetrafluoroethylene membrane would decrease seriously after laundry. In contrast, the water-pressure resistance of the one treated with the composite of the present invention would decrease slightly (as shown in FIG. 4), so treating with the composite could increase the water-pressure resistance of a porous polytetrafluoroethylene membrane and the times of uses thereof.

### (4) Test of Adsorption Property

As shown in Table 2, the composite of the present invention containing 6% free activated charcoal was tested, and the one containing 0% free activated charcoal was served as a control. In the control, the original weight of the sample was 34.9656 grams, and was 34.9913 grams after absorption, increasing 0.0257 grams. In the experiment, the original weight of the sample was 41.4806 grams, and was 41.6046 grams after absorption, increasing 0.124 grams.

TABLE 2

| | Control | Sample |
|---|---|---|
| Weight before absorption (g) | 34.9656 | 41.4806 |
| Weight after absorption (g) | 34.9913 | 41.6046 |
| Weight increase (g) | 0.0257 | 0.124 |
| Butane Activity (%) | 0.074% | 3% |

Through the test of ASTM D 5742-955, the butane activity of the control was 0.074%, and the experimental one was 3%, so the composite of the present invention had higher adsorption property.

Although this invention has been described in its preferred form with a certain degree of particularity, it is understood that the present invention of the preferred form has been made only by way of example and that numerous changes in the details of construction and the combination and arrangement of parts any be restored to without departing from the spirit and scope of the invention.

What is claimed is:

1. A composite comprising:
(1) porous carbon particles; and
(2) porous resin,
wherein the porous carbon particles are uniformly distributed and exposed outside on the surface of the porous resin.

2. The composite as claimed in claim 1, further comprising a solvent which entirely or partially dissolve in water and is selected form the group consisting of isopropanol, methyl ethyl ketone, ketone, water, toluene, N-dimethylformamide and mixture thereof.

3. The composite as claimed in claim 1, wherein the porous carbon particles are selected from the group consisting of free activated charcoal, carbon black, and graphite.

4. The composite as claimed in claim 1, wherein the size of porous carbon particles is between 0.1-1 micrometers.

5. The composite as claimed in claim 1, wherein the porous resin is consisted of polyurethane, phthalate or derivatives thereof.

6. The composite as claimed in claim 2, wherein the percentage of the solvent is 30-80(w/w %).

7. The composite as claimed in claim 1, which has adsorption, odor resistance, moisture-management, air permeability, water vapor permeability, water resistance and anti-peeling property.

8. A method of preparing a composite with adsorption, odor resistance, moisture-management, air permeability, water vapor permeability, water resistance and anti-peeling property, the method comprising steps of:
(1) mixing the porous resin with a solvent which entirely or partially dissolves in water;
(2) mixing the porous carbon particles with a solvent which can entirely or partially dissolve in water; and
(3) adding the product of Step (2) to the product of Step (1) slowly to distribute the porous carbon particles uniformly in the porous resin, and then fixing the mixture by curing from low temperature to high temperature.

9. The processing method as claimed in claim 8, wherein the percentage of the porous resin in Step (1) is 30-50%.

10. The processing method as claimed in claim 8, wherein the percentage of solvent which entirely or partially dissolve in water in Step (1) is 50-70%.

11. The processing method as claimed in claim 8, wherein the percentage of the porous carbon particles in Step (2) is 4-20%.

12. The processing method as claimed in claim 8, wherein the percentage of solvent which can entirely or partially dissolve in water in Step (2) is 90-97%.

13. The processing method as claimed in claim 8, wherein the ratio of the product of Step (2) and the product of Step (1) in Step (3) is 3:7.

14. The composite as claimed in claim 1, which can attach to the surface of polytetrafluoroethylene membrane.

15. The composite as claimed in claim 14, wherein the porous carbon particles are selected from the group consisting of free activated charcoal, carbon black, and graphite.

16. The composite as claimed in claim 14, wherein the size of porous carbon particles is between 0.1-1 micrometers.

17. The composite as claimed in claim 14, wherein the percentage of the solvent is 30-80(w/w %).

18. A method of preparing a porous polytetrafluoroethylene membrane with adsorption, odor resistance, moisture-management, air permeability, water vapor permeability, water resistance and anti-peeling property comprising steps of:
(1) mixing porous carbon particles with porous resin and a solvent which can entirely or partially dissolve in water to obtain a composite.
(2) distributing the composite uniformly to the surface of a polytetrafluoroethylene membrane or within it by coating or dipping; and
(3) drying out the membrane to remove the solvent and then attaching the composite to the surface of a polytetrafluoroethylene membrane or within it.

19. The method as claimed in claim 18, wherein the porous carbon particles are selected from the group consisting of free activated charcoal, carbon black, and graphite.

20. The method as claimed in claim 18, wherein the size of porous carbon particles is between 0.1-1 micrometers.

21. The method as claimed in claim 18, wherein the porous resin is consisted of polyurethane or phthalate.

22. The method as claimed in claim 18, wherein the percentage of the solvent is 30-80(w/w %).
